(19) United States
(12) Patent Application Publication
(10) Pub. No.: US 2018/0107529 A1
(43) Pub. Date: Apr. 19, 2018

(54) STRUCTURAL EVENT DETECTION FROM LOG MESSAGES

(71) Applicant: NEC Laboratories America, Inc., Princeton, NJ (US)

(72) Inventors: Pranay ANCHURI, PLAINSBORO, NJ (US); Fei WU, State College, PA (US)

(21) Appl. No.: 15/783,372

(22) Filed: Oct. 13, 2017

Related U.S. Application Data
(60) Provisional application No. 62/407,556, filed on Oct. 13, 2016.
(60) Provisional application No. 62/410,243, filed on Oct. 19, 2016.
(60) Provisional application No. 62/411,874, filed on Oct. 24, 2016.

(51) Int. Cl. G06F 9/54; G06F 17/30

(52) U.S. Cl. CPC G06F 9/542; G06F 2216/03; G06F 17/30539

(57) ABSTRACT

Aspects of the present disclosure describe structural event detection from system log messages. More particularly disclosed are computer-implemented methods to mine structural events as directed workflow graphs where nodes of the graphs represent log patterns and edges represent relations among patterns. Advantageously, the structural events are inclusive and correspond to interpretable episodes in the system and methods according to the present disclosure directly model the overall quality of structural events. Through both qualitative and quantitative experiments on real-world datasets, the effectiveness of the disclosed methods are demonstrated.

### CROSS REFERENCE TO RELATED APPLICATIONS

This application claims the benefit of U.S. Provisional Patent Application Ser. No. 62/407,556 filed Oct. 13, 2016, and U.S. Provisional Patent Application Ser. No. 62/410,243 filed Oct. 19, 2016, and U.S. Provisional Patent Application Ser. No. 62/411,874 filed Oct. 24, 2016, each of which is incorporated by reference as if set forth at length herein.

### TECHNICAL FIELD

This disclosure relates generally to the global Internet and more specifically the World-Wide-Web and services built thereupon. In particular, this disclosure describes structural event detection from log messages that are detected from groups of cohesive log patterns represented by workflow graphs.

### BACKGROUND

As is known, the contemporary connected world employs web applications in numerous aspects of life. As is known further by those skilled in the art, such modern web applications are served by a loosely set of coupled web services. Known further is the fact that enterprises expend great resources to ensure proper functioning of these web services as they (the services) now directly impact the quality and availability of applications employing same.

Simultaneous with the deployment of these Web services, their ubiquitous logging behavior generates voluminous rich text messages that are useful for monitoring the performance of the services and identifying risks associated with their use. However, the volume of messages and the highly dynamic nature of the Web make any monitoring and deriving information therefrom particularly challenging.

Accordingly, systems, methods and techniques that enhance the monitoring and derivation of information of Web services would represent a welcome addition to the art.

### SUMMARY

An advance in the art is made according to aspects of the present disclosure directed to a

a novel method to mine structural events as directed workflow graphs (where nodes represent log patterns, and edges represent relations among patterns). The structural events are inclusive and correspond to interpretable

In sharp contrast to the prior art, a.

### BRIEF DESCRIPTION OF THE DRAWING

A more complete understanding of the present disclosure may be realized by reference to the accompanying drawing in which:

FIG. 1(A) is a schematic illustrating a motivating example in which Log messages generated by a Retail Management Service (RMS) at a grocery store in which 1, and 2 mark the logs corresponding to manual entry and barcode scan events respectively, according to aspects of the present disclosure;

FIG. 1(B) is a schematic illustrating a structural event detected from messages wherein like arrows represent an event sequence according to an aspect of the present disclosure;

FIG. 2(A), FIG. 2(B), and FIG. 2(C) are graphs depicting energy value with respect to number of iterations for alternating update and mix update(s) for: FIG. 2(A)—Windows Server; FIG. 2(B)—RMS; and FIG. 2(C)—Browser(s); according to an aspect of the present disclosure;

FIG. 3(A), and FIG. 3(B) illustrate one structural event detected from RMS data wherein the event corresponds to the cashier inputs an item manually via keyboard in which: FIG. 3(A) shows structural event detected, where each node represents log patterns; and FIG. 3(B) shows semantics for each log pattern according to aspects of the present disclosure;

FIG. 4 is a graph showing the number of components in the resulting graph with respect to different values of λ_{c} according to aspects of the present disclosure; and

FIG. 5 is a schematic block diagram of an illustrative computer system on which methods of the present disclosure may operate according to an aspect of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The functions of the various elements shown in the Drawing, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the FIGs comprising the drawing are not drawn to scale.

By way of some further background we note that in today's connected world, Web applications help with numerous aspects of contemporary life. As will be appreciated, most such Web applications are provided/served by sets of loosely coupled Web services. Of particular interest—commercial enterprises expend significant resources to ensure proper functioning of these Web services as they may directly and significantly impact the quality and availability of the applications. At the same time, ubiquitous logging of the services generates rich text messages that are useful for monitoring the performance of the services and identifying any risk(s) associated therewith. However, the sheer volume of message and highly dynamic nature of the Web and services/applications built thereon render the problems associated with Web services monitoring from system logs particularly difficult.

To tackle this problem, numerous attempts and resulting studies have been made to mine various system events from logs, such as log patterns and relations between log patterns. While mined patterns are useful, such studies do not generally consider high level structures associated with such patterns.

According to an aspect of the present disclosure, we disclose that high level structures may represent more meaningful system events which can naturally be expressed by directed workflow graphs. We demonstrate our disclosure by using log messages collected by a Retail Management Service (RMS)—that is generally known in the art as a set of applications used by retailers to manage their business(es).

### Example 1.1

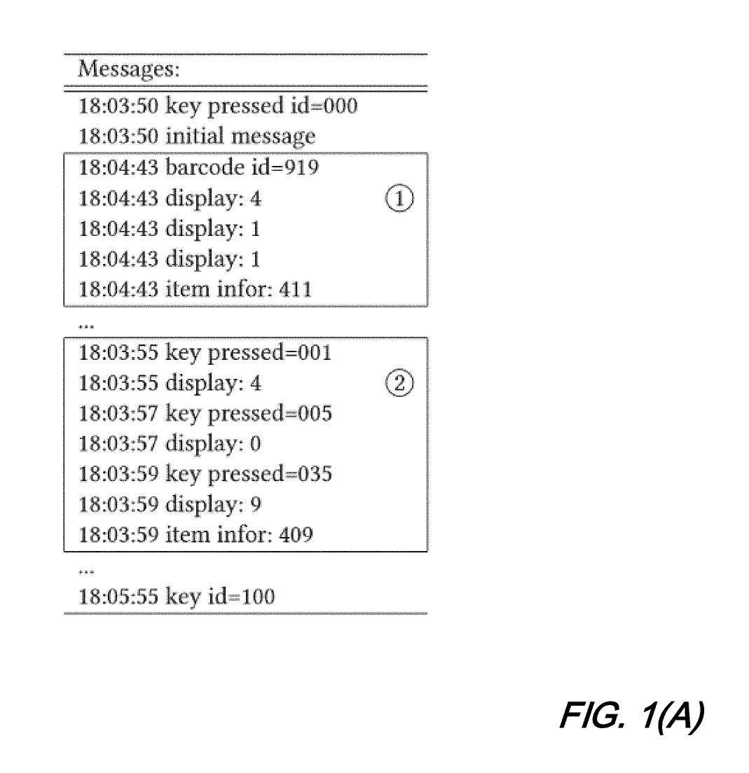

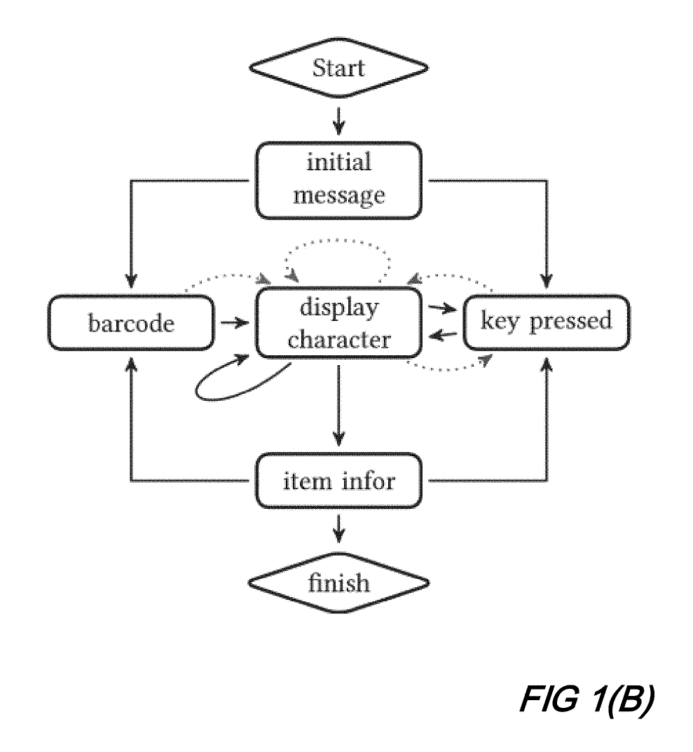

Consider a customer shopping in a retail store, a cashier working at a register using both keyboard and scanner based input methods to enter product(s) purchased by the customer. The actions by the cashier are registered as log messages by the store's RMS. FIG. 1(A) shows the log messages generated by this transaction.

As may be observed from FIG. 1(A), two major actions of this transaction are labeled by system administrators: A) scanning a product (id=411) using its barcode, and B) product with an id 409 is entered via keyboard. As may be observed, individual log messages contain limited semantic information—for example—the log at 18:03:55 just shows that key 4 is pressed. Note that the format of the log messages may indicate some patterns, e.g., key press and display character, but the patterns are hard to interpret and does not completely represent the intentions of the cashier.

At this point, one observation to be made is that the entire event (transaction) is reflected by structures including multiple transactions and patterns of logs. FIG. 1(B) shows a directed workflow graph generated by the patterns and the transitions. The graph representation associates isolated log patterns into structures that embed semantic information. One may further observe that a left part of the graph corresponds to scanning barcode, and the right part corresponds to manually entering an item code.

As may be appreciated, this example shows that important/meaningful system events are revealed by structures spanning multiple log patterns and their transitions. The directed graph does not merely visualize the intermediate transitions between patterns. More importantly it reveals structural relationships beyond just pairs of patterns. Therefore, we name such a directed workflow graph a structural event, and attempt to detect them from logs. Advantageously, meaningful structural events have shown to be very valuable in various application domains, such as monitoring system workflow, detecting sequence anomalies, and program workflow inspection.

However, automatically detecting such structural events is a challenging problem due—in part—to characteristics of log data. First, individual log messages contain limited information. For example, in FIG. 1(A), the log at 18:33:05 only shows that key 4 is pressed. This characteristic raises significant difficulties in detecting meaningful patterns (groups of logs). Second, a large proportion of the messages may be interleaved because of simultaneous task execution in distributed systems, as unique task identifiers may not be available. As a result, any temporal pattern relations mined from the raw data may be inaccurate and misleading. These characteristics require the structural event detection method to intelligently distinguish meaningful relations and patterns from the ones incurred by noise.

In the prior art, such structural events are extracted in a closed environment, where log messages are collected by running each application in isolation with as few background messages as possible. However, such learning process incurs a high cost and has limited usage. In sharp contrast—according to an aspect of the present disclosure—we take a data-driven approach to detect structural events from noisy log messages directly.

Furthermore, we address the limitation of a workflow graph in expressing higher-order sequential relations. More specifically, in FIG. 1, the two major events are reflected by two high order pattern sequences: i) barcode→display [symbol] marked by the red dashed arrows (a barcode scan followed by display of multiple characters), and ii) key pressed⇄display marked by the blue dashed arrows (each key press directly results in one character display). However, if we only consider the transition expressed by the edges, then the pattern sequence barcode→display→key pressed will be incorrectly considered as a valid transition. Note that higher-order information is particularly important for differentiating events with common log patterns (nodes). While literature have been focusing on proposing quality measures for detected patterns and relations, few looked at the work flow graphs resulting from connecting patterns with edges.

According to aspects of the present disclosure, we directly model the quality of the graph. In such an approach, we can not only consider the structure quality of the resulting events, but also account for errors in mined significant patterns and relations. We resort to the intuition that meaningful log patterns and relations often form workflow structures that are connected. We formulate our event detection problem as a graph editing task.

Our approach starts from a candidate graph containing all the mined patterns then gradually edit the graph (i.e., adding or deleting edges and nodes until a certain energy function is minimized). Intuitively, the structural events should include significant patterns and transitions for the system (i.e., high precision and high coverage). More importantly, we favor patterns and relations that are part of connected structures. The latter property translates to graph connectivity. We further extend our energy function to embed higher-order transitions and present a block optimization technique to solve the problem.

In summary, our novel contributions are as follows: 1) We study an important and challenging problem of detecting structural events from noisy log messages. 2) We disclose a novel data-driven approach that is readily applicable to any system logs and does not require domain knowledge about the system to learn the model. 3) We disclose an energy minimization formulation that can be solved efficiently. In sharp contrast to and as compared with existing approaches, our disclosed energy function better describes important structural events. We further extend our model to account for higher-order relations to eliminate ambiguity caused by edge representation.

Before describing our techniques in detail, it is first useful to compare/contrast summarized, related work from three aspects: i) Node discovery, ii) Dependency discovery, and iii) Model inference.

Node Discovery (Log Summarization).

This line of studies is focused on providing a precise summarization (i.e., clusters) of logs. As traditional clustering methods (e.g., k-means) designed for numerical data are not directly applicable, (as logs are often categorical and textual), researchers have proposed methods to cluster logs by frequent words, text templates, textual hierarchies, and log categories obtained by supervised methods.

To further consider the temporal information in the logs, Jiang et al. proposed to look at histograms of transition time between the log messages to find log patterns. The resulting log clusters consider the frequency of log appearances as well as the transition time among logs. Instead of improving the pattern discovery step, our proposal takes a complementary approach to model the quality of the graph. Advantageously, some of these earlier studies can be applied for node discovery in our framework.

Dependency discovery (Log dependency mining). Another line of studies has been focusing on mining dependency relations from the ordering of log messages. Various definitions of temporal dependency have been proposed, such as, forwarding conditional probabilities, transition invariants (e.g., A always follow B), and transition significance. These studies mainly focus only on mining reliable pattern relations from the data and do not consider the overall quality of the structural events.

Another long line of studies aims to mine higher-order sequential relations from data. Traditional frequent pattern mining approaches, such as sequential pattern mining, frequent episode mining can be applied to find important higher-order relations(sequences). Frequent pattern mining approaches often output large number of sequences with little variation. Many studies further reduce the result redundancy by using minimum description length principle, or an interestingness measure. However, the approaches do not consider how to summarize mined sequences into a workflow graph. Both lines of studies do not consider the quality of the workflow graphs after aggregating mined pattern relations.

In sharp contrast, methods according to the present disclosure directly model the characteristics of the global graph. By looking at the global structure, we find transition patterns that are structurally important but may exhibit a low quality score locally. Again—and advantageously, our disclosed approach and the previously described relation discovery methods are complementary. Notably our approach can build upon mined relations and sequences.

Workflow Model Inference.

Beschastnikh et al. proposed a system to generate program execution workflow graphs from log data. The generated graphs are later used in system debugging tools. Yu et al. proposed a system that utilizes pregenerated workflow graphs to monitor interleaved log messages on cloud computing services. Both studies use workflow graphs generated from log messages for monitoring and inspection purposes. Different from our work, the workflow graph generation methods assume that the logs are collected under a closed environment, i.e., log messages are collected by running each application in isolation with as few background messages as possible. Such learning process incurs a high cost and has limited usage in practice.

In sharp contrast, we detect structural events (i.e., graph) from noisy log messages directly.

Perng et al. also use Event Relation Networks (directed graphs) to represent temporal relations discovered. The graph construction step applies user-specified thresholds to filter insignificant relations. In practice, thresholds are hard to set. We will compare with threshold based methods and depict their problems in the experiments section. Furthermore, aforementioned studies do not consider higher-order sequential relations among patterns.

With this overall background in place, we now discuss the pipeline of our approach. The process of learning the nodes and learning the edges is subsequently disclosed and explained.

Pipeline

Generally, our approach includes three steps. Given a sequence of n log messages, M= [symbol] m1, m2, . . . , mₙ [symbol] , the first step converts raw messages into a stream of log patterns S= [symbol] p(s₁), p(s₂), . . . , p(sₙ) [symbol] , where p(sᵢ) represents the pattern id of message sᵢ. We denote the set of all log patterns as [symbol] ={p₁, p₂, . . . , pₗ}, where l is the total number of patterns mined. Log messages with similar syntactical structure usually correspond to system events that have the same semantic meaning. For example, in FIG. 1(A), messages following the regular expression “* barcode id: *” (* denotes wild cards characters) correspond to the barcode scanning event. Therefore, we discuss our proposed framework at the pattern level.

We follow earlier teachings to use regular expressions to cluster messages. More specifically, a regular expression tree is built using all the log messages, where different levels of the tree represent regular expressions at different specificity. We use the level where the number of clusters falls into a pre-defined range. Other log message clustering methods can also be applied to find patterns. We further mine transitional (sequential) relations among the patterns. As a result, we can obtain an initial workflow graph G*=(V*,E*) from the log pattern stream, where each node vϵV* represents a log pattern (i.e., a cluster of messages), and each eϵE*⊆V*×V* denotes a temporal relation mined from the pattern stream S. As the initial event graph may contain spurious edges, we seek important substructures that represent the system behavior. Therefore, our goal is to find:

G=arg min_{G}_{^{l}}_{⊆G*}E(G^{l}),

where G^{l} is a subgraph of the initial event graph G*, and function E( ) measures the quality of the summarized graph. We will discuss the detail of E( ) in following sections.

Learning Nodes

In a workflow graph, each node i is associated with a weight m(⋅) denoting the importance of the log pattern. Formally, we use normalized clustering size as the weight for each node, i.e.,

$$m ( i ) = \frac{\vert \{ p ( s ) = {p}_{i} \vert i ϵ \{ 1 , … , n \} \} \vert}{n} ,$$

where |⋅| is the cardinality of a set, and m(i)ϵ[0,1]. Note that other log clustering methods (mentioned previously) can also be applied for discovering meaningful log patterns, and more sophisticated measures can be used. Here, for simplicity, we only consider normalized clustering size as the weight function, as it is not the focus of this disclosure.

Learning Edges

To construct edges in the initial workflow graph, each node is connected with its neighbors. For our purposes, node i, and j are neighbors, if and only if there exists a transition from log pattern pᵢ to pattern pⱼ, i.e., ∃ t s.t. sₜ.p=pᵢ ∧sₜ₊₁.p=pⱼ, where pϵ [symbol] ={p₁, p₂, . . . , pₗ} is the set of all log patterns. The edges are weighed according to a quality measure q(⋅) quantifying the strength of the relation. Formally, we use the forwarding transitional probability as our edge quality measure q(⋅), i.e.,

$$q ( i , j ) = \frac{m ( i , j )}{m ( i )} ,$$

where m(i,j) is the number of times transition pᵢ→pⱼ occurs, i.e., m(i,j)=|{ [symbol] sₜ.p,ₛₜ₊₁.p [symbol] :sₜ.p=pᵢ∧sₜ₊₁.p=pⱼ}|. Note that we have q(i,j)ϵ[0,1]. Similarly, one may choose to use other formulations for the quality measure q(⋅) as mentioned previously.

Structural Event Detection

Given an initial graph G*=(V*,E*), where E* denotes a set of mined pairwise relations, the structural event detection is a graph editing process. The goal is to return a graph G=(V,E) (possibly disconnected) that represents important structural events of the system, where V⊆V*, and E⊆E*, and E*⊆V*×V*. Intuitively, the resulting graph G should include significant patterns and transitions of the system (i.e., high precision and high coverage). More importantly, as events often span multiple patterns and their transitions, we favor resulting structures that are more connected. The best structural events should therefore minimize the following energy function:

E=E_{E}+E_{V}+E_{G},

where E_{V} is a measure for the cost of including node set V, E_{E} measures the cost of including set of edges E, and E_{G} is a graph regularization term. We first give our complete energy function as:

$$E ( G ) = \underbrace{{λ}_{e} {\sum }_{e ∈ E}^{ } ( 1 - q ( e ) )}_{precision ( edge )} + \underbrace{{λ}_{r} {\sum }_{e ∈ {E}^{*} ∖ E}^{ } q ( e )}_{coverage ( edge )} + \underbrace{{λ}_{n} {\sum }_{t ∈ V}^{ } - m ( i )}_{coverage ( node )} + \underbrace{{λ}_{c} {\vert G \vert}_{d}}_{connectivity} , \qquad ( 1 )$$

where λₑ, λₙ, and λ_{c} are hyper-parameters controlling the effect of different components.

Edge Precision and Coverage:

As will be readily appreciated by those skilled in the art, since we want to include significant pattern relations in detected structural events, we define the energy term on the edges as:

$${E}_{E} = {λ}_{e} {\sum }_{e ∈ E}^{ } ( 1 - q ( e ) ) + {λ}_{r} {\sum }_{e ∈ {E}^{*} ∖ E}^{ } q ( e ) ,$$

where E is the set of edges in G, E*\E is a set of edges not included. The edge energy includes components measuring the precision and the coverage of edges respectively.

The edge precision term favors including transition relations that have high strength. The second term favors the case where all strong transitions are also covered in detected events. Without considering the coverage term, adding new edges within already connected components (without introducing new nodes) will not decrease the energy value. As a result, edges forming cyclic structures cannot be detected. For example, as shown in FIG. 1(A), when the cashier manually inputs an item code, the system first registers a key press event and displays the corresponding character. The action corresponds to key pressed⇄display patterns in the structural events. Even though both directions of the edge have similar importance, not considering the coverage on edges will likely to miss either the edge key pressed→display or the edge key pressed←display.

Node Coverage:

We define node energy to measure the coverage on node as:

$${E}_{V} = - {λ}_{n} {\sum }_{i ∈ V} m ( i ) ,$$

where m(i) measures the fraction of the times log patterni appears. The energy term favors including log patterns that appear more frequently. Similar formulations to include important nodes in the graphs are also used in other works.

Graph Connectivity.

One key observation we have made is that important system events often span multiple patterns and transitions of logs, the intuition translates to measuring the connectivity of the structural events. We define a term on the resulting graph structure using a graph regularization term as follows

E_{G}=|G|_{d},

where |G|_{d} is the number of connected components. Other connectivity measures, such as, pairwise node distances, are also applicable and yield similar results. We choose to use the number of connected components for ease of computation. A simple depth-first or breathfirst search takes linear time complexity with respect to the number of nodes and edges

Energy Minimization Via Graph Editing

One goal of methods according to the present disclosure is to mine subgraph structures that minimizes the energy function as in Equation(1). The energy function is not differentiable, as unknowns are discrete variables, and the connectivity term does not have closed form expression. Moreover, we can see that a naive search solution is infeasible because of the exponential number of possible subgraphs. Consequently, we use a Monte Carlo Markov Chain (MCMC) method to explore the search space more effectively.

MCMC

In a stochastic optimization approach, algorithms generate a new candidate based on the previous ones. In each candidate generation step, a newly generated candidate is compared to the previous candidate. If the new candidate has a better objective value, it will be accepted as the new solution, otherwise, it will be accepted with a probability proportional to its quality. The sequence of candidates is a Markov Chain. Metropolis-Hasting algorithm approaches the optimal solution using such a Markov Chain. Metropolis-Hasting algorithm includes two main steps namely, a proposal and an acceptance step. In the proposal step, a new graph configuration G′ is proposed by the function Q. Given the newly proposed configuration, the algorithm decides whether to accept the new configuration with a probability γ defined as follows

$$γ = min [ 1 , \frac{f ( {G}^{′} )}{f ( G )} \frac{Q ( G ; {G}^{′} )}{Q ( {G}^{′} ; G )} ] , \qquad ( 2 )$$

where Q(G′;G) is the proposal density function. The algorithm repeats the two steps until a stopping criterion is met. A common definition of f(G′) is:

$$f ( {G}^{′} ) = \frac{{exp}^{- E ( {G}^{′} ) / T}}{Z} ,$$

where Z=Σ_{∀G′}, e^{-E(G′)/T} is the partition function (i.e., normalizing constant), and T is the temperature parameter. Note that since γ is a ratio, we only need f(G) up to a constant factor. Hence, we do not explicitly compute Z. As we have introduced the basics for a stochastic optimization framework, we now proceed to explain our proposed method in greater detail.

Algorithm 1 SED(E*, Q, E)

```
Input: Mined relation set E*, proposal function Q, energy function
    E.
Output: Structural event graph G
  1: while Stopping criteria not met do
  2: G ← Gⁱ
  3: Propose G′ ← Q(G′; G)
  4: Compute γ(i) (Eq.6) with E(G) and E(G′).
  5: if U[0, 1] < γ(i) then
  6: Gⁱ⁺¹ ← G′
  7: else
  8: Gⁱ⁺¹ ← G
  9: end if
10: end while
11: return G
```

Proposal Density Function

While the choice of proposal density function can be an arbitrary one, the choice affects the convergence significantly. In the extreme case, an uniform proposal function will perform no better than doing a naive search. Following earlier work, the proposal function Q is designed to include modifications of graph edges and is defined as follows

$$Q ( {G}^{′} ; G ) = \{ \begin{matrix}{Q}_{a} ( {G}^{′} ; G ) , & p = 0.5 \\ {Q}_{d} ( {G}^{′} ; G ) , & p = 0.5\end{matrix} , \qquad ( 3 )$$

where Qₐ adds an edge e=i→j to G with a probability pa(e) defined as follows:

$${p}_{a} ( e ) = \frac{{exp}^{- ( 1 - q ( e ) )}}{{\sum }_{∀ {e}^{′} ∈ {E}^{*} \backslash E} {exp}^{- ( 1 - q ( {e}^{′} ) )}} , \qquad ( 4 )$$

and E* \E is the set of edges that are not already in the graph. The intuition is that the edges of higher quality are more likely to be included in the structural event graph. Q_{d} deletes one edge e=i→j from G with a probability p_{d}(e) defined as follows:

$${p}_{d} ( e ) = \frac{{exp}^{- q ( e )}}{{\sum }_{∀ {e}^{′} ∈ E} {exp}^{- q ( {e}^{′} )}} , \qquad ( 5 )$$

where E is the list of selected edges. The intuition is that an edge of lower quality is more likely to be deleted from the structural event graph. We do not define proposal functions on nodes, as selections on edges implicitly determines node selection as well.

Simulated Annealing

Metropolis-Hasting algorithm could suffer from long-mixing time (slow-convergence) because of low acceptance rate. Simulated Annealing adaptively sets the T in the Equation (3) to control the acceptance ratio γ.

Usually, the algorithm starts at a high temperature (a large T), where the distribution of f(G) is closer to a uniform distribution. Later, the temperature gradually reduces according to a cooling schedule. The process corresponds to a broad search at the beginning and gradually narrows down to a promising area for fine grained exploration. In this work, we adapt an exponential cooling schedule:

T(i)=T₀exp{−αi^{1/N}},

where N is the dimensionality of the model space, and we let N=2, α=0.8 and T₀=1. The new acceptance rate γ(i) varies over iterations as follows:

$$γ ( i ) = min [ 1 , \frac{{exp}^{- E ( {G}^{′} ) / T ( t )}}{{exp}^{- E ( G ) / T ( i )} \frac{Q ( G ; {G}^{′} )}{Q ( {G}^{′} ; G )}} ] \qquad ( 6 )$$

The optimization process is presented in Algorithm 1. The algorithm takes an edge set E*, initial temperature T₀, proposal function Q, and energy function E. While the stopping criterion is not met, the algorithm continues to examine new proposed structural events.

Several possibilities exist for the stopping criterion. Empirically, we found that stopping the algorithm when the energy value remains unchanged for 100 continuous iterations to be most effective. Finally, we study the time complexity of Algorithm 1. In each iteration, computing the graph energy, E(G), is the most expensive operation. It requires the computation of three terms: Edge energy, Node energy and Connectivity, each of which can be computed in linear time using graph traversal algorithms such as Depthfirst search. Given Nₘₐₓ iterations of the SED algorithm, the time complexity is, therefore, O((|V|+|E*|)×Nₘₐₓ).

Higher-Order Sequences

As we discussed previously, the edge formulation can only represent transitions between pairs of patterns. However, the log patterns may inherently embed higher-order sequential relations. We use Eₖ* to denote a set of high-order relations of length k, e.g., we have E*=E₂*, and E₃*={(i,j,k)}. Similar to the edge case, the higher order relations are also weighed by a quality measure q(⋅). Our goal here is to select important high-order relations Eₖ ⊆Eₖ* to enrich the structural event graph. We can similarly define an energy term that measures the precision and coverage of included relations,

$${E}_{{E}_{k}} = {λ}_{e}^{′} {\sum }_{e ∈ {E}_{k}} ( 1 - q ( e ) ) + {λ}_{r}^{′} {\sum }_{e ∈ {E}_{k}^{*} \backslash {E}_{k}} q ( e ) . \qquad ( 7 )$$

We further constraint that sub-relations of a higher-order relation eϵEk should be included in the selected edge set E. For example, we have (i,j,k)ϵE₃⇔(i,j)ϵE₂∧(j,k)ϵE₂. Correspondingly, we want the higher-order relations to explain important log patterns and have

$${E}_{{V}_{k}} = - {λ}_{n} {\sum }_{i ∈ V ( {E}_{k} )} m ( i ) ,$$

where V(Eₖ) is a set of log patterns (i.e., nodes) that selected higher order relations. In this disclosure, we only consider second order relations, i.e., E₃. The generalization to a larger k is straight-forward. Here, we define weights for high-order relations (of order 2) as:

$$q ( i , j , k ) = q ( ( i , j ) , k ) \times q ( i , ( j , k ) ) = \frac{m ( i , j , k )}{m ( i , j )} \frac{m ( i , j , k )}{m ( j , k )} ,$$

where m(i,j,k) is the frequency of transition i→j→k. The energy terms related to higher-order sequences are E_{Ek} and E_{Vk}. The higher-order energy E(Gₖ) is defined as follows

E(Gₖ)E_{E}_{ₖ}+E_{V}_{ₖ}. (8)

Accordingly, the joint energy function is given by:

E=E(G)+E(Gₖ), (9)

where E(G) is defined as in Equation 1.

Algorithm 2 BlockSED(E*, Eₖ*)

```
Input: Mined relation set E*, Eₖ*
Output: Structural event graph G
  1: G(V, E) ← SED(E*, Q, E)
  2: E_{filtered}* ← {(i, j, k) : (i, j) ∈ E ∧ (j, k) ∈ E, (i, j, k) ∈ Eₖ*}
  3: G(V, E, Eₖ) ← SED(E_{filtered}*, H, E)
  4: return G(V, E, Eₖ)
```

Block Optimization

To optimize the new energy function, we again use a MCMC approach with a proposal function H defined as:

$$H ( {G}^{′} ; G ) = \{ \begin{matrix}{H}_{a} ( {G}^{′} ; G ) , & p = 0.5 \\ {H}_{d} ( {G}^{′} ; G ) , & p = 0.5\end{matrix} , \qquad ( 10 )$$

where H is similar to the function Q defined previously with Hₐ and H_{d} representing addition and deletion operations. We can still use Equation 4 and Equation 5 to define editing probabilities, by replacing E* and E with high-order set Eₖ*, and Eₖ respectively. However, the minimization problem is easily stuck at some local optima, as we will show later. To address this problem, we describe a block optimization technique, where we optimize for each order of the relation in an increasing order. A key observation is that the proposal step on high-order relations will not change the energy terms computed on lower-order relations.

The detailed steps are shown in Algorithm 2. As may be observed, in line 1, we execute the SED algorithm only using the proposal function related to pairwise edge update, i.e., Q. Based on the result, we filter the set of high-order sequences in line 2. In line 3, we again run the SED algorithm with the proposal function H. The graph G with selected edges (E) and the higher-order sequences (Eₖ) is the structural event graph.

EXPERIMENTS In this section, we now discuss experiments performed on log messages collected from three different domains: back-end servers, management systems, and user applications. Results consistently show that our method outperforms various other approaches. Our qualitative results are backed by user studies and case studies

Datasets

For all three datasets, we generate ground truth workflow graphs on labeled data, which simulates a perfectly closed environment.

The labeled data was provided by domain experts different from the users participated in user study for Windows Server and RMS datasets. For the Web Browser dataset, we separate the logs by user id (as the unique identifier is presented in the dataset) and manually generate workflow subgraphs.

TABLE 1
Statistics of the datasets.

| Log Source | # messages | # patterns | # labels |
|---|---|---|---|
| Windows Server | 61,190 | 140 | 12 |
| RMS | 21,736 | 106 | 10 |
| Web Browser | 997,176 | 26 | 11 |

# labels column shows the number of labeled patterns we have for each dataset, i.e., number of patterns in the ground truth structural event.

Windows Server.

The Windows server data includes log messages from a Windows server at a data center. The log messages are collected over a two-month period. The server primarily runs two types of services: (i) database back-up services, and (ii) logcollection processes for the data center. The back-up services are automatically invoked periodically and the log-collection processes are invoked by user requests. As we do not force the server to run under a closed-environment, large amount of the logs are irrelevant to the two services. We manually labeled the log data for these two types of services.

Retail Management Service (RMS).

The RMS data includes log messages from a retail management system. The log messages are collected over a one-month period and has 21,736 messages in total. Domain experts have provided us with expected events during a normal operations of the RMS. These include events corresponding to product scanning, which we use for comparison. The ground truth graph contains 10 log patterns.

Web Browser.

The web browser dataset includes log messages generated from a Firefox browser on a computer for one week. The dataset contains 997,176 messages. Each log message is associated with an event code reflecting the corresponding browser event, e.g., loading plugins, opening tabs, or allocating memory. We manually label log messages that correspond to common browsing actions: open/close tab, add/delete/move bookmark, follow links, and install plugin. We generate a ground truth work flow graph from the labeled data.

Table 1 summarizes the statistics of the datasets. In each case, the ground truth only describes a fraction of the system functionality, i.e., there may exist other meaningful log patterns and pattern transitions that are not included in the ground truth. Therefore, we only consider log patterns that are included in the ground truth and evaluate the structure induced by those selected patterns.

Evaluation Metrics

The output of our problem is a directed graph G=(V,E). Therefore, we evaluate the result based on similarity between resulting graph and the ground truth graph. Specifically, we use precision and recall of the edges as the metric (measures on the nodes give similar results). Given a ground truth graph G_{g}=(V_{g},E_{g}), precision measures the fraction of edges in G that are also in the ground truth graph, i.e.,

$$P = \frac{\vert E ⋂ {E}_{g} \vert}{\vert E \vert} .$$

Recall measures the fraction of edges in the ground truth graph that are recovered in the result graph G, i.e.,

$$R = \frac{\vert E ⋂ {E}_{g} \vert}{\vert {E}_{g} \vert} .$$

We also report F₁ score that considers both precision and recall, i.e.,

$${F}_{1} = 2 \frac{PR}{P + R} .$$

We only report the precision and recall for the edge set E.

Comparisons

In this disclosure, we compare our method against four state-of-the-art and baseline methods that extract structural events.

Threshold Method.

In this method, structural events are detected from an initial workflow graph by simply filtering out all edges with q(e)<θ, θ is a threshold parameter. We use two thresholds 0.1 and 0.5 for comparison. The threshold method considers only the quality of each relation.

StoryLine.

Earlier researchers have proposed a story line extraction method for summarizing progressing news events. Given a text query, a subgraph is retrieved based on the textual similarity between the query and the documents. In this subgraph, each node represents a text document and each directed edge represents the similarity between documents (with temporal ordering). Each node is also weighed by its dissimilarity to the query. StoryLine extracts minimum weight dominating set of the subgraph and searches for a directed Steiner tree that connects nodes in the set. We use l−m(i) as the weight for log pattern (node) i and directly use the log patterns appeared in the ground truth as the retrieved subgraph. The method can extract tree like events.

K-Cores.

We compare with a purely connectivity based detection method. K-cores of a graph are maximally connected subgraphs in which each vertex has degree more or equal to k. We set K=3. The K-cores represents densely connected components of the graph. We further filter edges with quality lower than 0.1. This baseline considers the connectivity of resulting structural events.

ESRE.

Still others have proposed a unified event summarization and detection framework (ESRE). ESRE aims to detect sequential events, such as, a person getting on a bus and sitting, from surveillance videos. The proposed approach first extracts important image segments from video frames. Image segments are connected based on their temporal and spatial proximity. The images segments and their connections are fed into a graph editing algorithm to mine causal events via minimizing an energy function. Compared with our energy function, their energy function does not consider the connectivity and coverage of the resulting graph. As a result, the method is likely to miss important cyclic structures and split complete structural events into smaller ones. We compare our method with the graph-editing step of ESRE.

Performance on Real Datasets

We now disclose the performance of compared methods on all three datasets. Table 2 summarizes the results of all compared methods. We can see that our Structural Event Detection SED method achieves the best F₁ score compared against other methods, i.e., 0.9, 1 and 0.86 on Server, RMS, and Browser datasets respectively.

TABLE 2
Precision, recall and F-1 scores for compared
method on the three datasets respectively.

| | | Threshold (θ = 0.01) | Threshold (θ = 0.5) | StoryLine | K-cores | ESRE | SED |
|---|---|---|---|---|---|---|---|
| Server | P | 0.76 | 0.82 | 0.33 | 0.46 | 1 | 0.87 |
| | R | 0.82 | 0.64 | 0.28 | 0.93 | 0.5 | 0.93 |
| | F1 | 0.33 | 0.72 | 0.31 | 0.61 | 0.67 | 0.9 |
| RMS | P | 0.8 | 1 | 0.75 | 0.72 | 1 | 1 |
| | R | 1 | 0.75 | 0.37 | 1 | 0.25 | 1 |
| | F1 | 0.88 | 0.86 | 0.5 | 0.84 | 0.4 | 1 |
| Browser | P | 0.67 | 0.77 | 0.3 | 0.18 | 0.83 | 0.75 |
| | R | 1 | 0.83 | 0.25 | 1 | 0.41 | 1 |
| | F1 | 0.8 | 0.8 | 0.27 | 0.31 | 0.56 | 0.86 |

By varying the threshold from 0.1 to 0.5 in threshold, the precision increases by nearly 0.1 across the three datasets but at the same time, the recall decreases by nearly 0.3. This depicts the problem of a threshold based method. While a higher threshold keeps edges having higher quality, many edges in the complete events may be missed. With a lower threshold, edges of complete events may all be included, however, many incorrect relations will also be included. A precise threshold value is hard to know, and even non-existent. In our approach, such a trade-off is measured based on the contribution of an edge to the overall quality instead.

StoryLine has F₁ score no more than 0.5 across the datasets, as the method explicitly assumes a tree structure connecting important nodes. However, structural events often contain cyclic strictures as illustrated in FIG. 1(B). Both major events, i.e., scanning barcode, and input item code, contain cyclic structures of log patterns. ESRE achieves the best precision, i.e., 1, 1, and 0.83 precision on the three datasets respectively. However the recall values are low, i.e., 0.5, 0.4, and 0.41 on the three datasets respectively. This is because the energy function does not consider coverage of the edges in the result. Adding new edges within already connected components (does not introduce new node) will not decrease the energy value. As a result, edges forming cyclic structures cannot be detected. Furthermore, the energy function does consider the connectivity of the graph. Therefore, edges connecting important sub-structures (while may appear infrequently) will be missed. K-cores method achieves high recall, i.e., 0.93, 1 and 1 on all the three datasets. However, the precision is low as it purely focuses on the connectivity of the resulting model. The experiment shows that our proposed method performs the best as it considers precision, coverage, and connectivity of the resulting graph jointly.

Convergence of Block Optimization

We now study the convergence of our SED Algorithm 2. We compare our block update strategy with vanilla stimulated annealing approach (i.e., mix update), where we use the following proposal function Q′:

$${Q}^{′} ( {G}^{′} ; G ) = \{ \begin{matrix}Q ( {G}^{′} ; G ) , & p = 0.5 \\ H ( {G}^{′} ; G ) , & p = 0.5\end{matrix} .$$

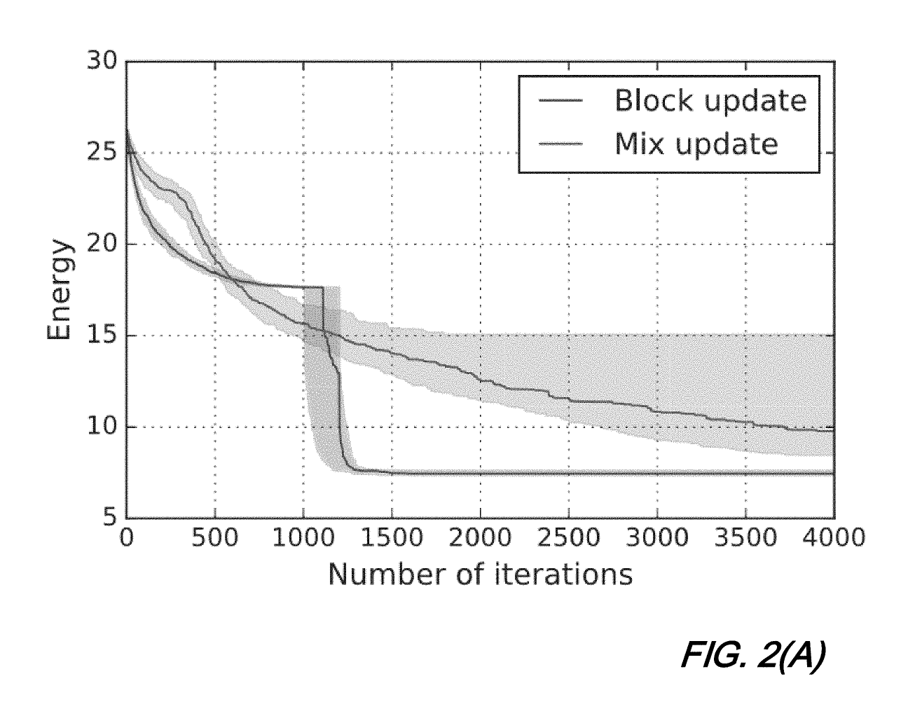

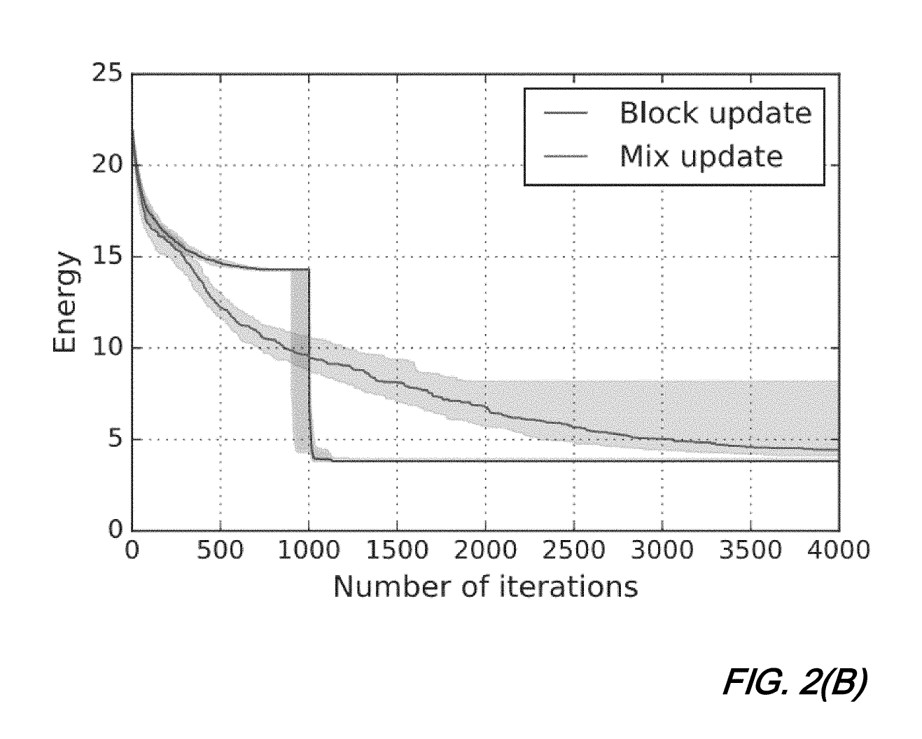

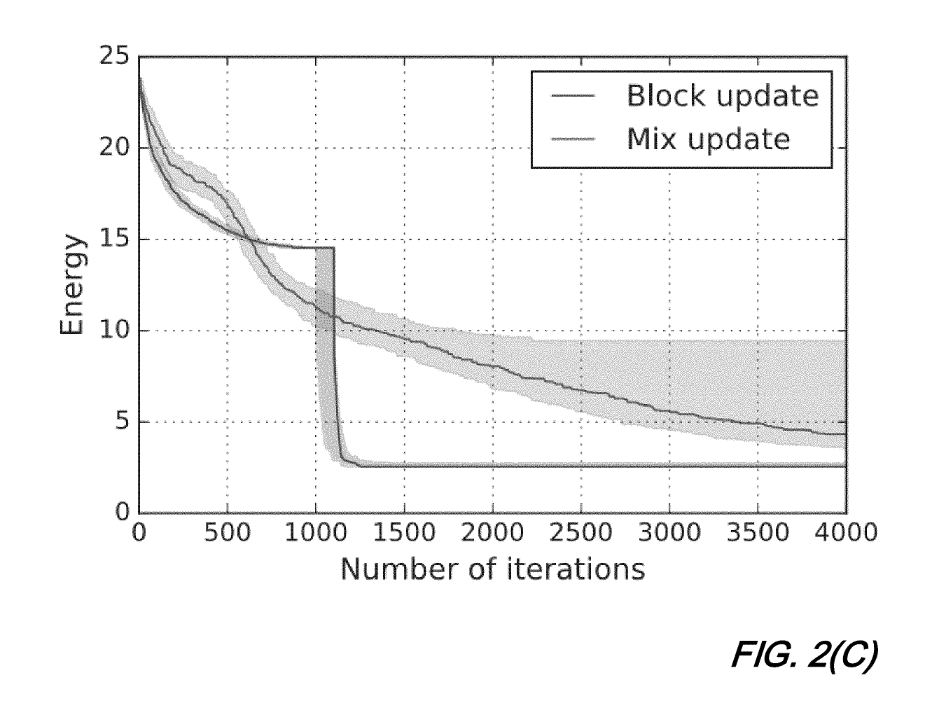

There is an equal chance for a high-order update and an edge update operation to happen. FIGS. 2(A), 2(B), and 2(C) show the energy value with respect to the number of iterations for both inference approaches on three datasets for 100 runs. The solid line represents the median energy value, and the color bands mark the runs between the first and the third quantile. We can see that block-update approach reaches convergence at iterations 1500, 1100, and 1200 for Windows Server, RMS and Web Browser datasets respectively, while the mixed approach needs about 4000 iterations to converge on the three datasets. At the same time, our proposed approach reaches a lower energy state compared against the mix update approach. Furthermore, we can see that these results of mixed update approach are unstable as the first and the third quantile cover a large area. These results suggest that the update is easily stuck at some ill-posed local optima. This is because once an ill-posed update gets accepted, it is very hard for the algorithm to undo the step after a few edge updates have occurred. Therefore, ill-posed higher-order updates occurring at the early iterations of the methods would affect the results significantly. The large variation in the result of the vanilla stimulated annealing makes the method impractical.

User Study on Higher-Order Relations

To evaluate the interpretability of resulting structural events with higher-order relations, we conducted a user study where 19 users were asked to rank the outputs from different methods. The user group is composed of 9 graduate students (majoring in computer science or related fields) and 10 domain experts. BlockSED is used as our method, as we also show the higher-order relations in the detected structural events. For browser data, we asked the users to rank the models based on whether the resulting models reflects normal browsing behavior. For server data, we inform the subjects that the server periodically runs back-up services and collects logs. We asked the users to mark the results that best reflects the two major events. For each user, models from five methods are shown. The method ranked at the best will gain two points and the method ranked at the second gains one point. Table 3 summarizes the user rating normalized by the maximum score a model can achieve. Events detected by SED are consistently ranked either as the first or the second. As a result, SED achieves better user rating on the datasets.

TABLE 3
User ratings of compared methods.

| | BlockSED | ESRE | K-cores | StoryLine | Threshold |
|---|---|---|---|---|---|
| Server | 0.42 | 0.08 | 0.37 | 0.37 | 0.2 |
| Browser | 0.56 | 0.23 | 0.29 | 0.08 | 0.5 |

Parameter Study

We now study the effect of the four parameters: λₑ, λᵣ, λₙ and λ_{c} on the energy function given by the equation 1 and describe a process for tuning these parameters. For simplicity, we assume that all these parameters lie in the range [0,1].

Edge Parameters λₑ and λᵣ:

We first derive a condition under which include an edge, e, when minimizing the graph energy. From Equation 1 we can see that the net increase in energy by including the edge e is given by the Equation 11.

δ(e)=λₑ×(1−q(e))−λᵣ×q(e) (11)

Since our objective is to minimize the energy, we want δ(e)<0. Therefore, we include an edge when q(e)>λₑ λₑ+λᵣ. This inequality serves as a guideline for choosing λₑ and λᵣ based on empirical knowledge. Note that edges having q(e)≤λₑ λₑ+λᵣ may still be included. In our experiments, we let λₑ=0.3 and λᵣ=0.7.

Node Parameter λₙ:

We found that the values of λₙϵ[0,1] do not affect the result for our datasets, as the selection of nodes is also implicitly considered in EE.

Connectivity Parameter λ_{c}:

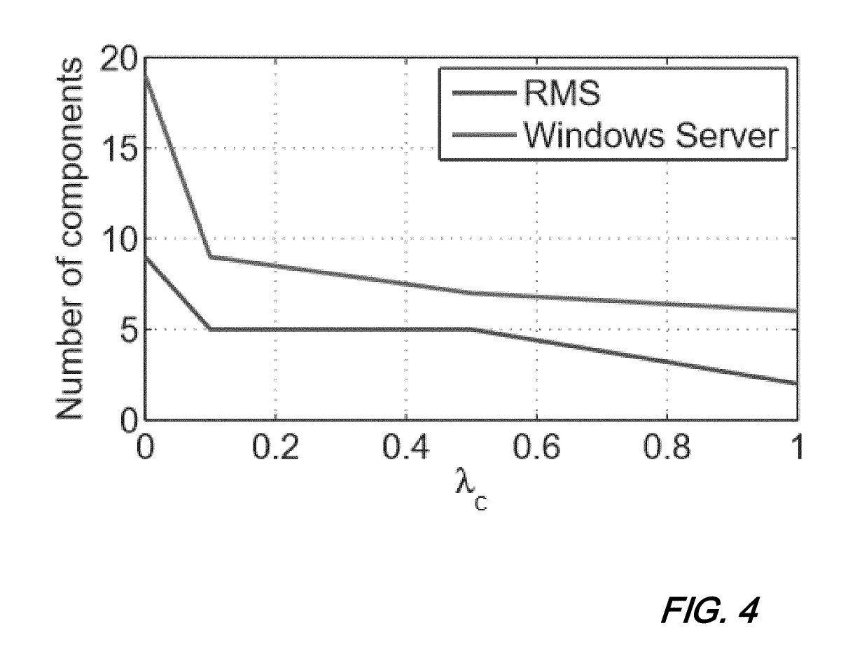

We ran experiments on RMS and Windows Server datasets since they have a higher number of patterns as the Table 1 indicates. FIG. 4 shows the number of components in the resulting event graph for different values of λ_{c}. We can see that when λ_{c}=0 (without the connectivity constraints) the event graph is split into 9 and 19 disconnected components in the two datasets. Moreover the number of components vary less (6 to 2 and 9 to 6) as λ_{c} increases from 0.1 to 1. These results suggests that the detected events are not sensitive to the value of parameter λ_{c}.

Case Study

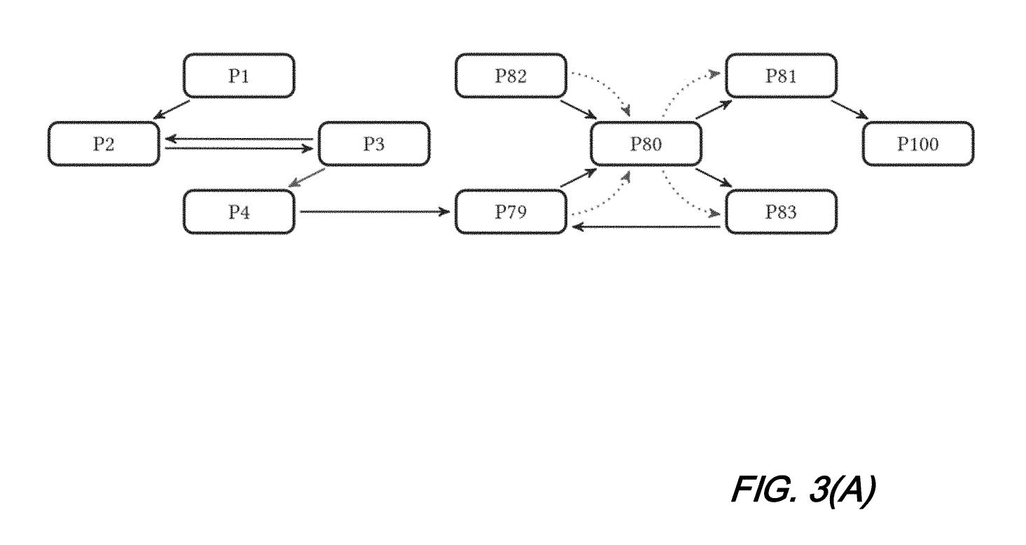

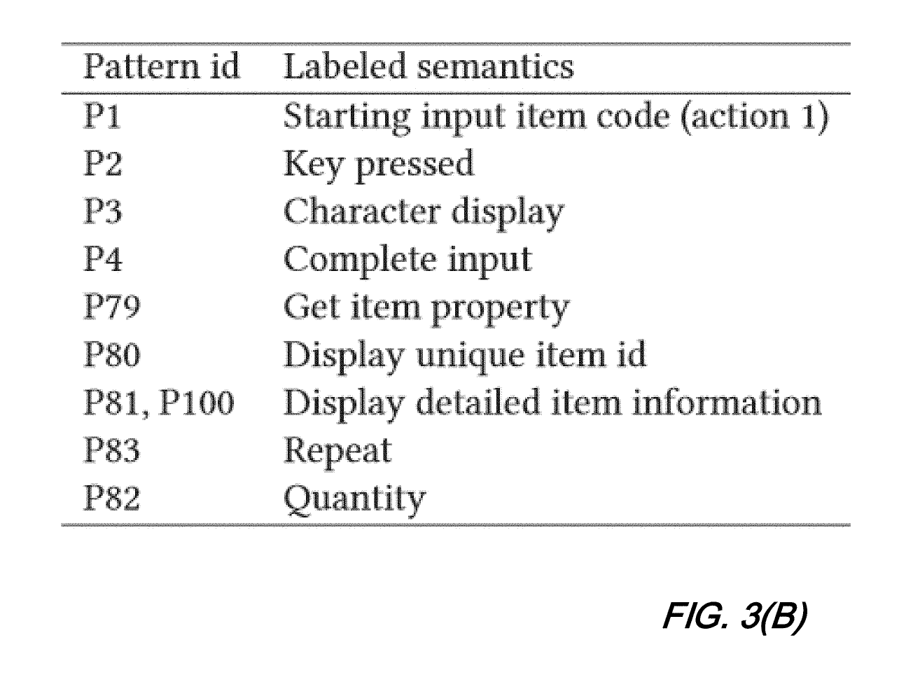

We now perform qualitative analysis on the event detected in RMS data. We show that our model performs the best in unraveling the underlying event. FIG. 3(A) shows the event detected by the Algorithm 2. The raw logs are first clustered into log patterns using regular expressions. The semantics for patterns are shown in FIG. 3(B). The entire structural event describes the message flow when the cashier inputs an item manually via keyboard.

Pattern P1, P2, P3 and P4 represents logs generated by pressing keys. Whenever a key is pressed, the corresponding character will be displayed on the screen. Therefore, we see a loop between pattern P2 and P3. The bidirectional transitions between P2 and P3 happen frequently. We note that ESRE method is likely to miss either transition from P2 to P3 or from P3 to P2, as it does not consider the coverage of relations in the energy function. At the same time, StoryLine method cannot detect the loop structure, as it assumes that the progression of news events follows a tree structure. Moreover compared to P3→P2, the transition P3→P4 happens far less frequently, as multiple keys need to be pressed to input an item. Threshold based method can easily miss transition P3→P4, as it is relatively infrequent. One may lower the threshold to include the transition. But, many irrelevant transitions will also be included as a side effect. Advantageously, methods according to the present disclosure can correctly include this transition by considering the connectivity of the graph. Starting from the pattern P79, the rest of the structural event describes the message flow corresponding to displaying behavior of the system. The message flow after entering an item code should be P79→P80→P81 and then to P100. At the same time, P82 represents another action in the system that leads to displaying behavior (patterns leading to P82 are not shown for brevity), which generates message flow P82→P80→P83. If we only consider transitions between two patterns, P80→P81 and P80→P83 are both valid, which should not be the case. The contextual information (whether P80 is preceded by P82 or P79) is extremely important in anomaly detection applications. The dashed lines in FIG. 3 represent the results of high-order constraints. Compared to all other methods, methods according to the present disclosure can easily incorporate the high-order information.

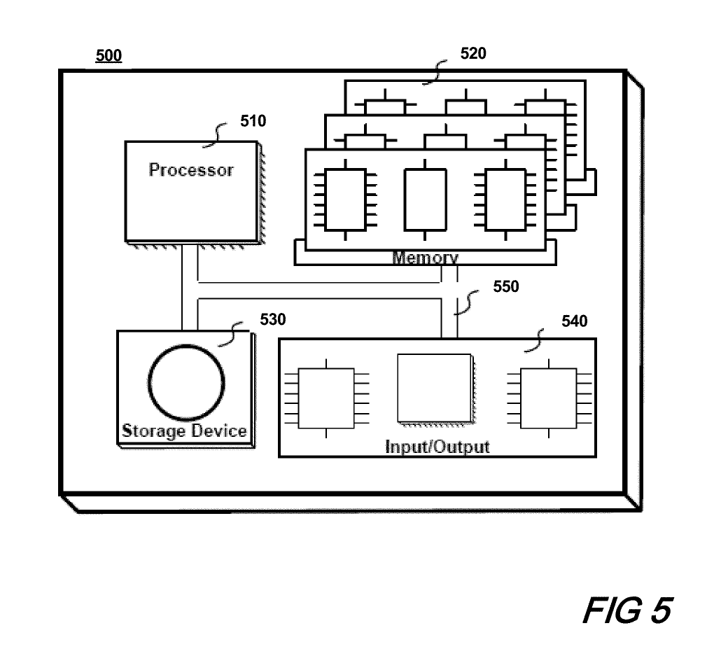

Finally, FIG. 5 shows an illustrative computer system 500 suitable for implementing methods and systems according to an aspect of the present disclosure. As may be immediately appreciated, such a computer system may be integrated into another system and may be implemented via discrete elements or one or more integrated components. The computer system may comprise, for example a computer running any of a number of operating systems. The above-described methods of the present disclosure may be implemented on the computer system 500 as stored program control instructions.

Computer system 500 includes processor 510, memory 520, storage device 530, and input/output structure 540. One or more input/output devices may include a display 545. One or more busses 550 typically interconnect the components, 510, 520, 530, and 540. Processor 510 may be a single or multi core. Additionally, the system may include accelerators etc. further comprising the system on a chip.

Processor 510 executes instructions in which embodiments of the present disclosure may comprise steps described in one or more of the Drawing figures or Algorithm steps illustrated in Algorithm 1, and Algorithm 2. Such instructions may be stored in memory 520 or storage device 530. Data and/or information may be received and output using one or more input/output devices.

Memory 520 may store data and may be a computer-readable medium, such as volatile or non-volatile memory. Storage device 530 may provide storage for system 500 including for example, the previously described methods. In various aspects, storage device 530 may be a flash memory device, a disk drive, an optical disk device, or a tape device employing magnetic, optical, or other recording technologies.

Input/output structures 540 may provide input/output operations for system 500.

### CONCLUSIONS

We have disclosed a method to mine structural events from log messages. The structural events are useful for status monitoring and detecting abnormal behavior sequences. We have disclosed a data driven approach that can be readily applied on normal system running logs (as oppose to logs generated under a closed environment). Our methods model the quality of the graph structure and embeds higher-order sequential relations.

At this point, while we have presented this disclosure using some specific examples, those skilled in the art will recognize that our teachings are not so limited. More specifically, our methods can be further extended in that the structural events can embed more temporal information and consider more sophisticated structures including considering more finegrained temporal information, e.g., the transition time distribution, to enrich mined structural events. Also, we have focussed on transition relations among log patterns. There are other useful relations among logs, such as running in parallel that may be employed. Those relations can be further modeled in the workflow graph using undirected edges. We also believe that the methods according to the present disclosure can achieve more utility in an interactive setting, where system admins can interactively explore the system behaviors with different focusses (parameter settings) on coverage, quality or connectivity.

Accordingly, this disclosure should be only limited by the scope of the claims attached hereto.

1. A computer-implemented method for determining structural events from log messages comprising:
by a computer:
converting a stream of n log messages M [symbol] =m₁, m₂, . . . , mₙ [symbol] into a stream of log patterns S= [symbol] p(s₁), p(s₂), . . . , p(sₙ) [symbol] , where p(sᵢ) represents a pattern ID of message sᵢ;
clustering the messages by constructing a regular expression tree using all the log messages, where different levels of the tree represent regular expressions at different specificity;
generating an initial workflow graph G*=(V*, E*) from the log pattern stream where each node vϵV* represents a log pattern (i.e., a cluster of messages), and each eϵE*⊆V*×V* denotes a temporal relation mined from the pattern stream S;
determining
G=arg min_{G}_{^{l}}_{⊆G*}E(G^{l}),
where G^{l} is a subgraph of the initial event graph G*, and function E( ) measures the quality of the summarized graph; and
determining an initial workflow graph G*=(V*, E*) from the log pattern stream where each node vϵV* represents a log pattern (i.e., a cluster of messages), and each eϵE*⊆V*×V* denotes a temporal relation mined from the pattern stream S; and
determining, from the initial workflow graph in which E* denotes a set of mined pairwise relations, a graph G=(V, E) that represents important structural events of the system; and
outputting the determined structural events.

2. The computer-implemented method of claim 1 wherein the structural events determined minimize the following energy function:
E=E_{E}+E_{V}+E_{G},
where E_{V} is a measure for the cost of including node set V, E_{E} measures the cost of including set of edges E, and E_{G} is a graph regularization term.
